(19) United States
(12) Patent Application Publication
(10) Pub. No.: US 2025/0306731 A1
(43) Pub. Date: Oct. 2, 2025

(54) ADAPTIVE DYNAMIC GUIDANCE IN DATA ANALYSIS TOOLS

(71) Applicant: Adobe Inc., San Jose, CA (US)

(72) Inventors: Arpit Ajay Narechania, Atlanta, GA (US); Jane Hoffswell, San Jose, CA (US); Shunan Guo, San Jose, CA (US); Eunyee Koh, San Jose, CA (US); Prithvi Bhutani, San Jose, CA (US)

(73) Assignee: Adobe Inc., San Jose, CA (US)

(21) Appl. No.: 18/618,638

(22) Filed: Mar. 27, 2024

(51) Int. Cl. G06F 3/0482; G06F 9/451

(52) U.S. Cl. CPC G06F 3/0482; G06F 9/453

(57) ABSTRACT

In one aspect, a computer-implemented method includes accessing, by a guidance module of an analysis application executing on a processor, wildcard data associated with data in a data repository. The method further includes displaying, by the guidance module based on the wildcard data, one or more wildcard elements in a graphical user interface (GUI). The method further includes receiving, by the analysis application, selection of a first wildcard element of the one or more wildcard elements. The method further includes displaying, by the guidance module, a suggestion based on the selection of the first wildcard element.

### BACKGROUND

Data analysis tools include features to allow users to interact with data records. However, users often have varying knowledge of the data. For example, some users are familiar with a dataset, while others may not have prior experience with the dataset. Similarly, a given user's knowledge of the data often evolves over time. Moreover, the access patterns of different data records by a user often does not reflect the distribution of values in the data. Therefore, different types of guidance are beneficial for different users and/or for the same user.

### BRIEF SUMMARY

Embodiments are generally directed to techniques for adaptive, dynamic guidance in data analysis tools. The guidance may be adaptive to accommodate different interactions between users and the analysis tools, such that the users and the analysis tool can understand intentions. The guidance may be dynamic because the knowledge gap between the user and the system may vary over time. For example, as a user becomes more familiar with a dataset, the analysis tool may not need to provide more detailed guidance to the user. More specifically, the guidance may include wildcard suggestions to allow the user to quickly engage with the data. The guidance may further include suggestions to allow the user to fully explore the breadth of a dataset. Embodiments are not limited in these contexts.

Any of the above embodiments may be implemented as instructions stored on a non-transitory computer-readable storage medium and/or embodied as an apparatus with a memory and a processor configured to perform the actions described above. It is contemplated that these embodiments may be deployed individually to achieve improvements in resource requirements and library construction time. Alternatively, any of the embodiments may be used in combination with each other in order to achieve synergistic effects, some of which are noted above and elsewhere herein.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A illustrates an aspect of the subject matter in accordance with one embodiment.

FIG. 1B illustrates an aspect of the subject matter in accordance with one embodiment.

FIG. 1C illustrates an aspect of the subject matter in accordance with one embodiment.

FIG. 1D illustrates an aspect of the subject matter in accordance with one embodiment.

FIG. 2A illustrates an aspect of the subject matter in accordance with one embodiment.

FIG. 2B illustrates an aspect of the subject matter in accordance with one embodiment.

FIG. 2C illustrates an aspect of the subject matter in accordance with one embodiment.

FIG. 3 illustrates an aspect of the subject matter in accordance with one embodiment.

FIG. 4 illustrates a system 400 in accordance with one embodiment.

FIG. 5 illustrates a logic flow 500 in accordance with one embodiment.

FIG. 6 illustrates a computer-readable storage medium 602 in accordance with one embodiment.

FIG. 7 illustrates a computing architecture 700 in accordance with one embodiment.

FIG. 8 illustrates a communications architecture 800 in accordance with one embodiment.

### DETAILED DESCRIPTION

Exemplary embodiments are generally directed to techniques for adaptive dynamic guidance in data analysis tools. The guidance is dynamic by providing a different degree and/or amount of guidance to different users and/or the same user at different times. The guidance is adaptive by having the tool ask follow-up questions to learn from the user, or having the user provide direct feedback to the tool. Some embodiments include providing wildcards as a mode of guidance to the user. Wildcards generally track aspects of the data (e.g., the quality of the data, the use of the data, etc.), one or more users (e.g., the focus on data by users, access of data by users, etc.), and/or a particular task (e.g., deviation of the user's focus from a predetermined goal, etc.). In some embodiments, the wildcards are generated based at least in part on tracking interactions with the data (e.g., viewing data records, saving data records, generating reports or other visualizations using the data, etc.) by a plurality of users. The wildcards are used in a graphical user interface (GUI) to provide guidance via one or more of visual encodings, filtering operations, or sorting operations. For example, the analysis tools assign a “guidance for user focus” wildcard to a “color” visual encoding channel for the user, which orients the user to view the relevant data and maintain differential focus on the data. As another example, the wildcard is used to sort data and/or filter data in the analysis tool, allowing the user to explore the sorted and/or filtered data. As another example, the user can assign (or reassign) a wildcard to receive guidance through visualizations (e.g., animations, annotations, etc.), which preserves the user's preferred encoding, sorting, and filtering configurations.

Furthermore, the adaptive dynamic guidance disclosed herein includes guidance to encourage a user to access data records according to one or more predetermined thresholds. For example, if data values include “yes” or “no” values and the thresholds include 50% for the “yes” values and 50% for the “no” values, the system may guide the user such that the number of “yes” and “no” records accessed by the user approaches 50%, respectively. For example, if 66% of the records selected by the user are “yes” records, the system may provide guidance to allow the user to select more “no” records. The guidance may include suggesting particular data records (and/or types of data records) for selection and/or suggesting avoiding particular data records (and/or types of data records). The adaptive dynamic guidance disclosed herein further includes recommendations to enhance reports, visualizations, or any other type of output based on data records. Embodiments are not limited in these contexts.

In some embodiments, the guidance is outputted using one or more of natural language expressions, before and after GUI transitions in a “guide me” panel, and/or a popover-based tour. In some embodiments, the particular type of guidance is selected by the system by computing a need for the guidance by the user and/or one or more user preferences. In some embodiments, a chatbot is used to guide the user. Embodiments are not limited in these contexts.

Often, users require guidance when learning new tools and/or when accessing different datasets. The users often require guidance regardless of their knowledge of the tools and/or underlying datasets. In addition, there are different moments during a user's interaction with the tools that warrant additional guidance, especially when the user is unsure if their analysis is complete, objective, and effective. By providing wildcards to guide users about what data has previously been used in their organization (e.g., a work organization, school organization, etc.), users can relate faster and better to the data. Furthermore, the wildcards provide the users with an initial starting point for subsequent analysis. For example, by guiding the user to select a particular data dimension (e.g., the “country” field) that has been used in 80% of previous projects, embodiments disclosed herein provide users with a specific data dimension to access, while also highlighting the popularity and importance of the data dimension. Continuing with this example, when the user drags the suggested dimension into a particular element within the GUI of the analysis tool, the countries of various data records are populated in the GUI of the analysis tool. The analysis tool then suggests dragging another metric to the GUI, where the suggested metric includes contextual information (e.g., “the revenue metric is commonly used with the country dimension”). Doing so allows the tool to guide the user towards a meaningful (and not just arbitrary) analysis report based on prior usage. More generally, doing so overcomes conventional techniques by allowing users to more quickly access relevant data records (e.g., by presenting relevant data records or suggestions on how to access relevant data records), identify relevant data types (e.g., by presenting relevant data types or suggestions on how to access relevant data types), adhere to data access thresholds (e.g., by monitoring the data accesses relative to the threshold and causing the accesses to approach the threshold), and/or generate more accurate analysis reports (e.g., by generating the reports based on relevant data).

Although exemplary embodiments are described in connection with a particular system, the principles described herein can also be applied to other types of systems as well. Embodiments are not limited in this context.

### Term Definitions

As used herein, the term “analysis application” refers to any type of analysis application. An analysis application is designed to collect, process, analyze, and visualize data to help users gain insights into various aspects. As such, an analysis application can be used to make data-driven decisions. Analysis applications can handle large datasets and use various techniques such as statistical analysis, data mining, predictive modeling, and machine learning to extract meaningful patterns and trends. Analysis applications provide users with reports, dashboards, and visualizations that make it easier to understand complex datasets. One example of an analysis application is Adobe® Analytics.

As used herein, the term “guidance module” refers to any type of hardware, software, or combination of hardware and software that is designed to assist users by providing helpful suggestions, recommendations, and/or instructions. The guidance module utilizes various techniques to understand user behavior, preferences, and context, offering personalized guidance to enhance the user experience.

As used herein, the term “logging module” refers to any type of hardware, software, or combination of hardware and software that logs user interaction events within a graphical user interface. The events include button clicks, mouse hovering, accessing data records, wildcard selections, accepted suggestions, rejected suggestions, assigning values, selecting threshold types, defining threshold values, menu selections, form submissions, and any other actions within the GUI. As events are detected, the logging module may store indications of the events in an interaction log. Records in the interaction logs include timestamps, an identifier of a user of the GUI, an indication of the event, and an indication of any associated data records in a data repository.

As used herein, the term “wildcard data elements” refers to any type of data elements generated based on organizational and/or individual use.

As used herein, the term “data repository” refers to a location where data is stored, managed, and accessed. A data repository is a structured and organized storage system for any type of data, including documents, files, databases, images, videos, and audio.

As used herein, the term “graphical user interface” (GUI) refers to a visual interface that allows users to interact with electronic devices, software applications, and operating systems through graphical elements such as icons, buttons, menus, and windows.

As used herein, the term “suggestion” refers to a recommended action, solution, or course of action provided by software based on processing data, input, context, and/or predetermined criteria.

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

In the Figures and the accompanying description, the designations “a” and “b” and “c” (and similar designators) are intended to be variables representing any positive integer. Thus, for example, if an implementation sets a value for a=5, then a complete set of components 121 illustrated as components 121-1 through 121-a may include components 121-1, 121-2, 121-3, 121-4, and 121-5. The embodiments are not limited in this context.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all operations illustrated in a logic flow may be required in some embodiments. In addition, a logic flow may be implemented by a hardware element, a software element executed by a processor, or any combination thereof. The embodiments are not limited in this context.

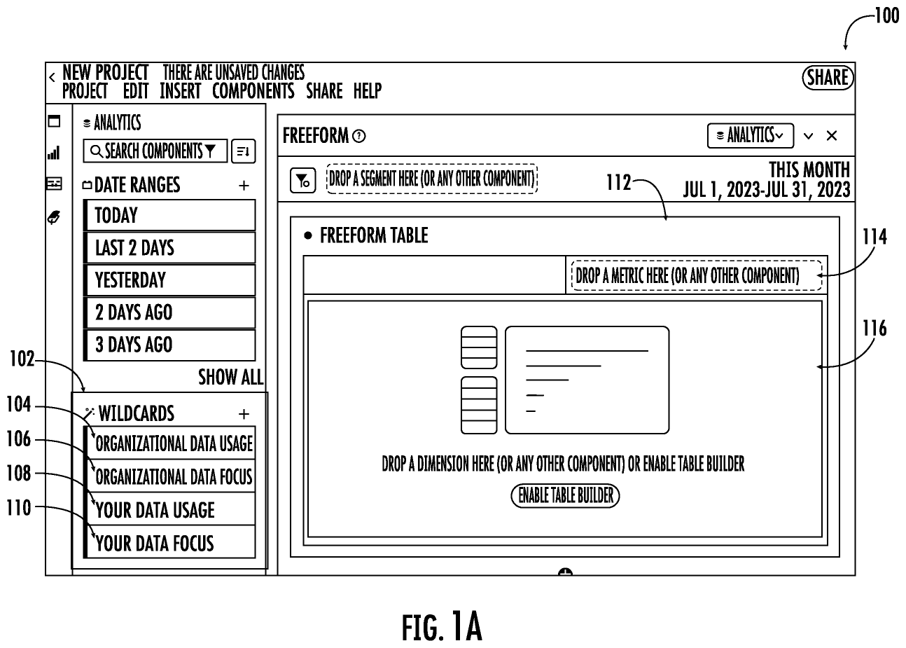

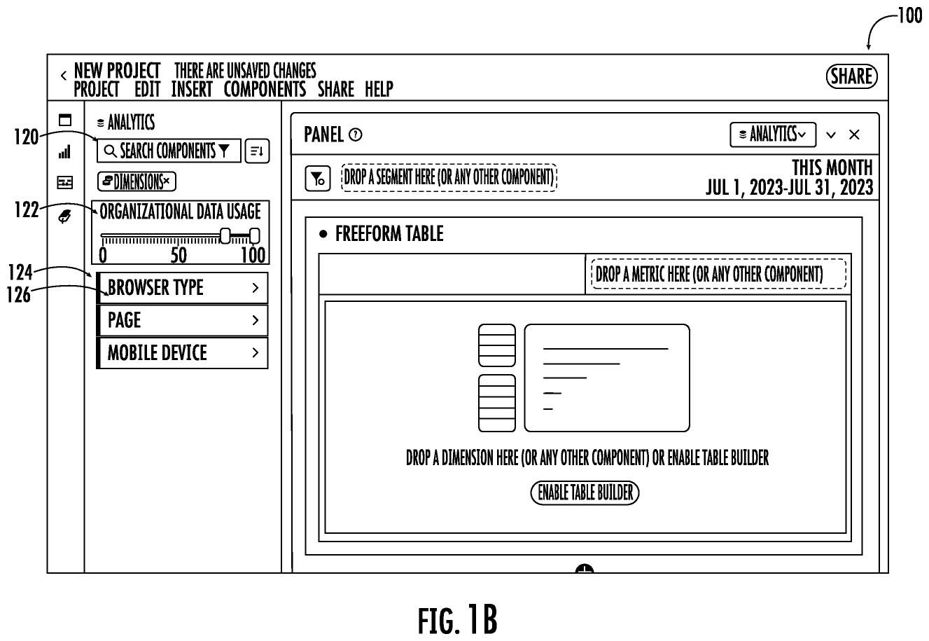

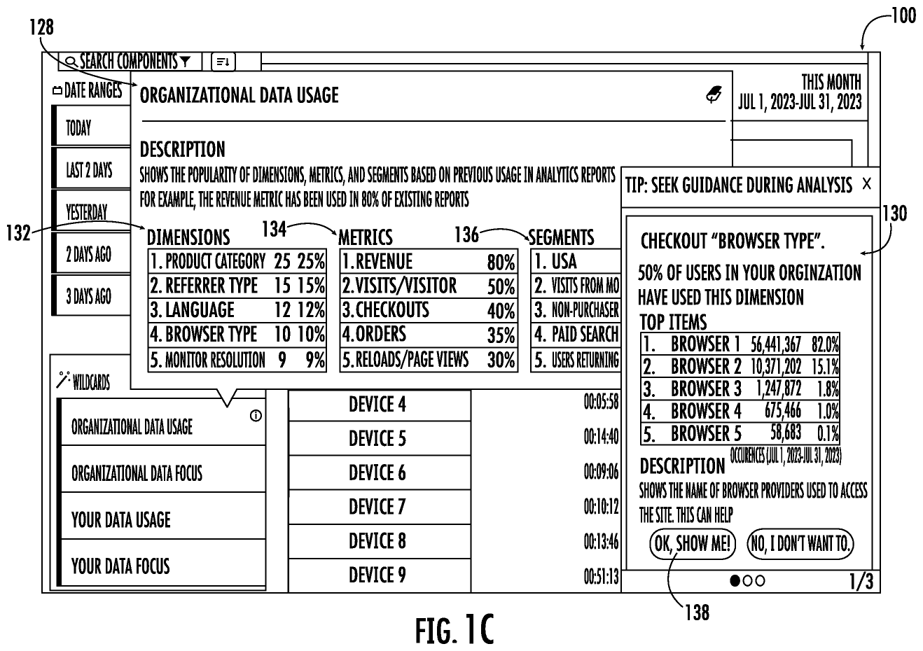

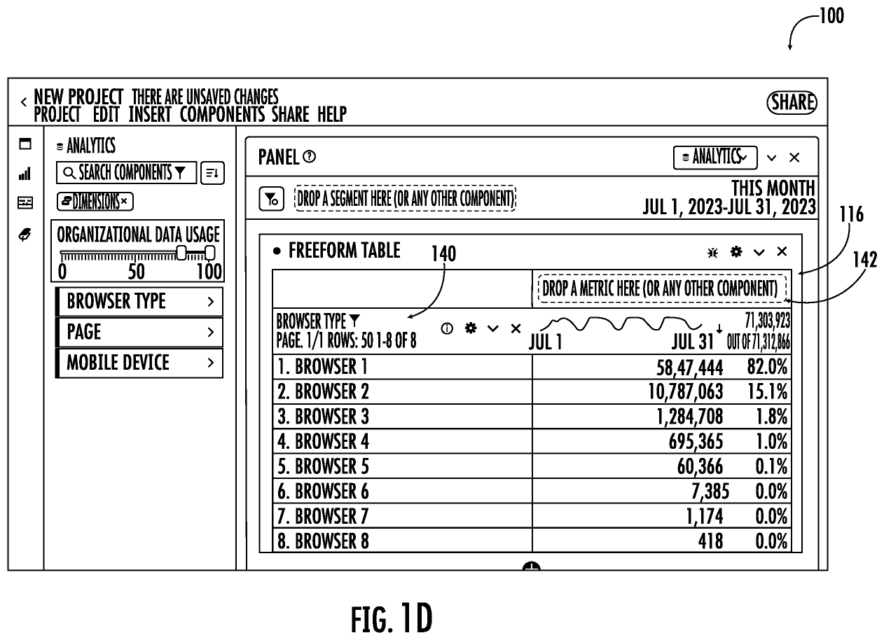

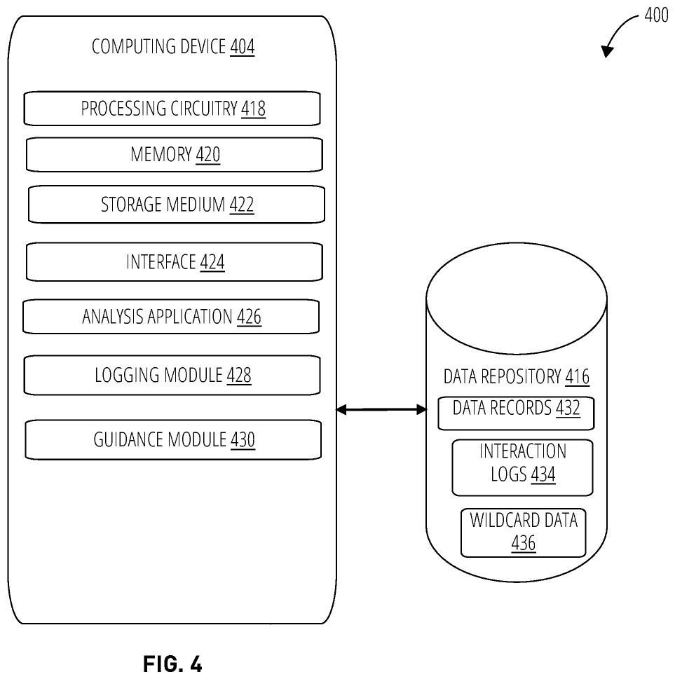

FIG. 1A illustrates an example graphical user interface (GUI) 100 that provides guidance to users. The GUI 100 may be included in an analysis application such as the analysis application 426 of FIG. 4. Initially, the user may provide one or more data records (and/or a location thereof) in a data repository to the analysis application. Generally, the GUI 100 includes a wildcard component 102 and a freeform table component 112. The wildcard component 102 generally provides one or more selectable wildcard data elements that can be dragged to a focus element 114 and/or the table view component 116 of the freeform table component 112. In some embodiments, the focus element 114 and the table view component 116 are used to specify the layout of a table, with the focus element 114 providing the columns of a table and the table view component 116 providing the rows of the table. Although the table view component 116 is an example interface to create visualizations of data, other types of interfaces may be used, and the use of the table view component 116 should not be considered limiting of the disclosure.

The wildcard data in the wildcard component 102 may be based on an analysis of data, the user accessing the data, and/or users interacting with the analysis application (including but not limited to interactions within the GUI 100 or other GUI elements of the analysis application). For example, as shown, the wildcard component 102 includes an organizational data usage wildcard element 104, an organizational data focus wildcard element 106, a user data usage wildcard element 108, and a user data focus wildcard element 110. More generally, the wildcard data may be considered as a metric (e.g., a quantitative value) that is viewed over a dimension (e.g., a categorical value and/or date range).

The organizational data usage wildcard element 104 is a wildcard data element that allows the user to view data that is ranked based on respective use amounts within an organization. The organization may include business organizations, school organizations, government organizations, social organizations, or any type of organization. The use amounts are based on any use factor, including but not limited to, accessing data records, saving data records, generating visualizations using the data records, using data records to make a decision, archiving data records, or any other type of use. For example, if each data record has an attribute “type” which includes values such as “animals,” “pets,” and “toys” among other values, the organizational data usage wildcard element 104 displays a subset of the “type” values and associated computed use amounts as a metric value within the GUI 100 when selected. Furthermore, the values such as “animals,” “pets,” and “toys” are used to determine a filter and/or sort operation to make viewing individual values easier. A logging module logs user interaction events within the analysis application, including GUI 100 and GUI 200, to facilitate the determination of usage amounts.

Similarly, the organizational data focus wildcard element 106 is a wildcard data element that allows the users to view data that is ranked based on focus amounts describing the amount of focus the data receives within the organization. The amount of focus may be based on any number and type of use factors, such as the number of times a data element receives focus (e.g., is clicked or otherwise selected) to learn further information about the data element. Therefore, if each data record has a “location” attribute with example values of “country”, “state”, and “city”, among other values, the organizational data focus wildcard element 106 displays a subset of the “location” values and associated computed use amounts as a metric value within the GUI 100 when selected. Furthermore, the values such as “country”, “state”, and “city” are used to determine a filter and/or sort operation to make viewing individual values easier. The logging module logs focus amounts in the analysis application, including GUIs 100 and 200, to facilitate the determination of focus amounts. In some embodiments, focus amounts may be based on the recency of data accesses, e.g., by weighting recent accesses more than the older accesses.

The user data usage wildcard element 108 is a wildcard data element that is similar to the organizational data usage wildcard element 104, but is limited to data use amounts for a specific user. Similarly, the user data focus wildcard element 110 is a wildcard data element that is similar to the organizational data focus wildcard element 106, but is limited to data focus amounts by a specific user. Therefore, the user data usage wildcard element 108 and the user data focus wildcard element 110 may provide wildcard elements that are tailored to a specific user.

FIG. 1B illustrates an embodiment of the GUI 100 based on selection of a wildcard element such as organizational data usage wildcard element 104 of FIG. 1A. The GUI 100 has applied two filters. In the example depicted in FIG. 1B, the user has filtered by “Dimensions” via the filter element 144. The user has also applied a filter using one of the wildcard elements 122, to the dimensions with the highest organizational data usage. Doing so displays one or more associated data types in the results section 124, including a browser type wildcard element 126.

As shown, the GUI 100 includes a search element 120 that allows different data types or data records to be searched. For example, the search element 120 is used to directly search data records (e.g., searching for “visit” yields both “visits” and “unique visitors”). The filter component 122 allows users to specify a filtering value to filter results from the results section 124. The filtering value is associated with a data type, data value, and/or properties thereof. In the example depicted in FIG. 1B, the filtering value in the filter component 122 is associated with an organizational data usage wildcard element 104. For example, setting the filtering value for the organizational data usage wildcard element 104 to 50% filters data records and/or data types that are used by 50% (or more) of other users (and/or other use scenarios) within an organization. Therefore, for example, the results in the results section 124 have an organizational data use value of 50% or greater (e.g., the “browser type”, “page”, and “mobile device” data types are used by more than 50% of users in the organization). Doing so removes other data types without 50% or more specified data values.

FIG. 1C illustrates various guidance types provided via the GUI 100. As shown, when the user hovers over (or selects) the organizational data usage wildcard element 104, a data view component 128 shows an ordered subset of different data types. The example data types in the data view component 128 include dimensions 132, metrics 134, and segments 136. The dimensions 132, metrics 134, and segments 136 are representative of any type of data and/or data type. As shown, the values in the dimensions 132, metrics 134, and segments 136 illustrate example data usage metrics. For example, the product category dimension 132 is associated with a 25% use in the organization, while the revenue metric 134 is associated with 80% use in the organization, etc.

The suggestion element 130 of the GUI 100 provides a suggestion to use the “browser type” dimension 132. The suggestion element 130 is generated by the guidance module and generally includes an indication that 50% of the users in the organization have used browser type (e.g., in reports, when viewing data, etc.). The suggestion element 130 further includes an ordered subset of the top ranking browser types (e.g., example browsers 1-5) and associated percentages. The user may then accept the suggestion using the show me element 138.

FIG. 1D illustrates an embodiment where a user has chosen to view browser type data records. To display the GUI 100 in FIG. 1D, the user chooses the browser type element 126 of FIG. 1B or the show me element 138 of FIG. 1C. Doing so causes browser type data records 140 to be displayed in the table view component 116. Therefore, any interface for receiving input in the GUI 100 in FIGS. 1A-1D is configured to receive input from the user and/or the analysis application (e.g., via the guidance module). As shown, the records in the browser type data records 140 are ordered by a respective occurrence value 142, e.g., the number of data records that specify the associated browser as the browser type. Doing so allows the user to view the most popular web browsers. When a given data record is selected, the logging module may store an indication of the same in the log. Embodiments are not limited in these contexts.

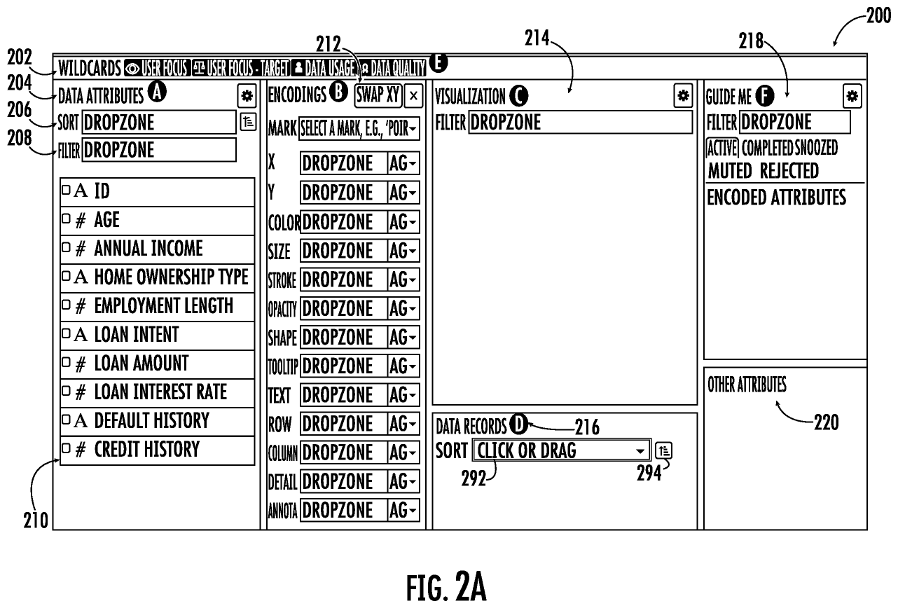

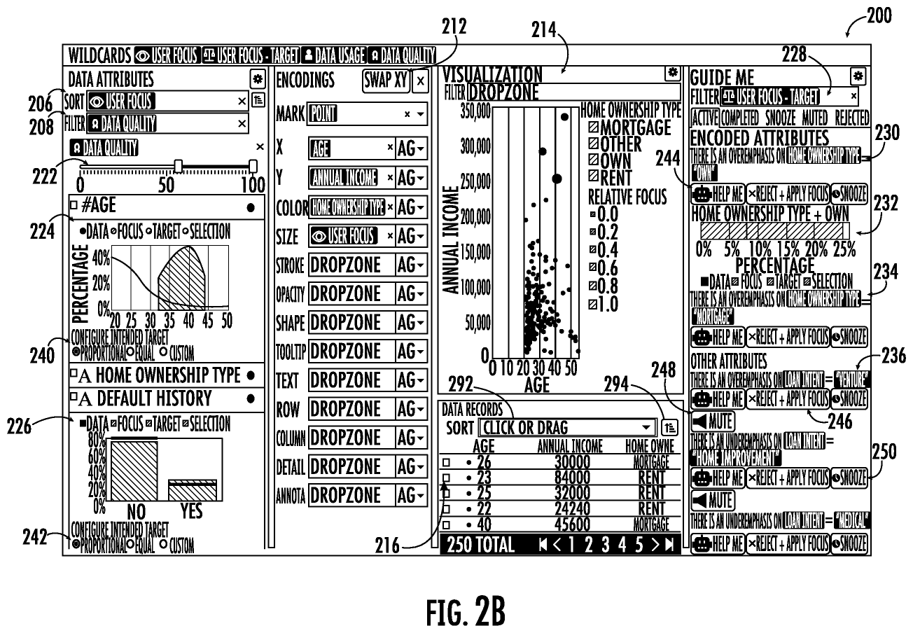

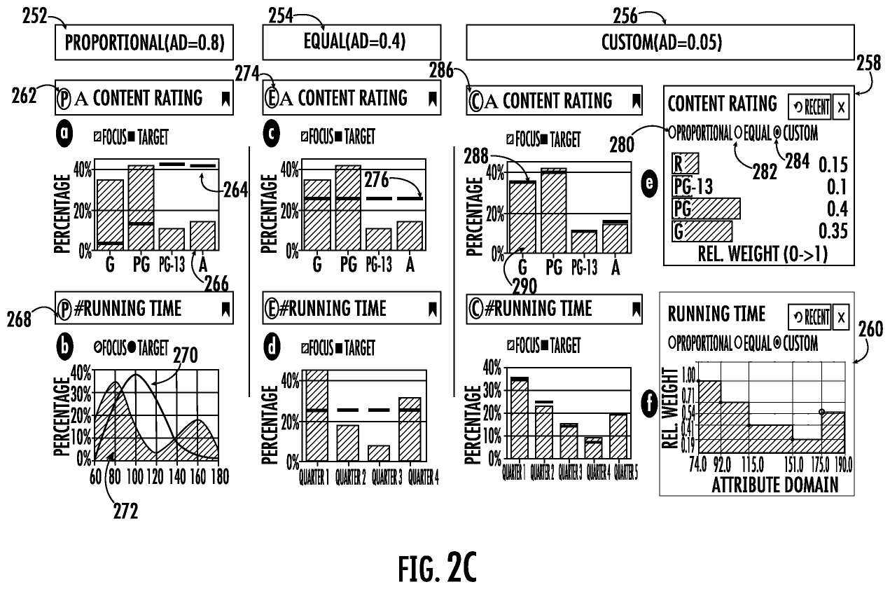

FIG. 2A illustrates a GUI 200 of the analysis application. Initially, a user may provide one or more data records in a data repository (and/or a location thereof) to the analysis application. The analysis application then processes the data, e.g., to identify data attributes (e.g., columns in a tabular format) and data records (rows in the tabular format). As shown, the GUI 200 includes a wildcard element component 202, a data attributes component 204, an encodings component 212, a visualization component 214, a data records component 216, and a guidance component 218 (which includes an other attributes component 220). The wildcard element component 202 displays one or more wildcard elements. The data attributes component 204 includes a sort element 206 and a filter element 208. The sort element 206 defines an interface for providing a sorting value that can be used for different types of sorting. For example, the sort element 206 sorts the list of attributes as specified. Sorting within the data records component 216 will sort data attributes based on the sorting value provided to sort element 292 (e.g., to sort data records based on an attribute such as “age” from the attributes 210) according to sorting direction 294 (e.g., sorting in ascending alphabetical order, etc.).

The filter element 208 defines an interface for providing a filtering value to filter data attributes displayed in the data attributes component 204 (e.g., to filter based on a wildcard such as user focus, etc.). Stated differently, filtering using the filter element 208 allows the user to select the attributes with the highest or lowest focus (e.g., based on the focus wildcard elements). In some embodiments, filtering within visualization component 214 using the focus wildcard elements allows the user to select the data records with the highest or lowest focus (which is updated in both the visualization component 214 and data records component 216).

The encodings component 212 provides a plurality of interfaces defining visualizations generated in the visualization component 214. For example, the encodings component 212 includes interfaces for a desired visualization type (e.g., point chart, bar chart, line chart, etc.), the x-axis and y-axis values, colors, sizes, etc. The guidance component 218 displays one or more suggestions to the user as described herein. Any one of the interfaces displayed in the GUI 200 of FIGS. 2A-2D is configured to receive input from the user or the analysis application itself (e.g., via the guidance module). Similarly, the logging module logs user interaction events within the GUI 200 of FIGS. 2A-2D. For example, when a data record is selected via the visualization component 214 and/or data records component 216, the logging module may store a corresponding indication in the log.

When a user selects an attribute 210, the analysis application opens a detailed view with a visualization (e.g., age attribute visualization 224 or default history attribute visualization 226 of FIG. 2B). The visualization may generally summarize the values of the data records.

The wildcard elements described herein may be dragged to a plurality of user interface elements (e.g., any field in the encodings component 212), sort element 206, filter element 208, etc.

FIG. 2B illustrates the GUI 200 in greater detail. As shown, the “user focus” wildcard has been provided as input to the sort element 206, while the data quality wildcard has been provided as input to the filter element 208. Therefore, the list in the data attributes component 204 is sorted by the amount of user focus a given data record has received and is filtered based on the data quality filtering value specified via filter component 222.

The encodings component 212 has received input specifying to create a chart 238 where age is the x-axis, annual income is the y-axis, the color is based on home ownership type, and the size of each data point in the chart 238 is based on the user focus each data record is associated with. Therefore, larger data points in the chart 238 indicate that the user has interacted with these records more than the smaller data points in chart 238.

The guidance component 218 includes a filter component 228, status tabs, and one or more suggestions including a suggestion 230, suggestion 234, and suggestion 236. The suggestions 230, 234, and 236 are organized into two groups, an encoded attributes group (suggestions for attributes included in the visualization 232 such as home ownership type) and other attributes group (suggestions for attributes not yet visualized in the visualization 232 such as loan intent). For example, the filter component 228 specifies “user focus” as a wildcard filter, where “user focus” is associated with the number of data records accessed by the user. The suggestion 230 includes a suggestion generated by the guidance module. The suggestion 230 is based on a threshold value associated with the home ownership data type and the number of records accessed by the user (e.g., via the chart 238 and/or the data records component 216). The thresholds are specified by the user and/or the guidance module. The user specifies thresholds via various GUI elements such as threshold selection interface 240 or threshold selection interface 242 of FIG. 2B or the interfaces in FIG. 2C. The guidance module specifies thresholds based on the actual distribution of the data records and/or proportional values. In the proportional example, if 60% of the data records are associated with ownership and 40% are associated with renting, the guidance module specifies a 60% threshold for ownership and a 40% threshold for renting (as these thresholds mirror the distribution of the data records). In the equal example, the guidance module provides equal thresholds. Therefore, continuing with the rent or ownership example, the guidance module defines a 50% threshold for renting and a 50% threshold for ownership.

The visualization 232 is shown when a user selects a suggestion such as suggestion 230. The visualization 232 and the suggestion 230 indicate that the user has accessed more data records associated with a value of “own” for home ownership than the threshold value associated with “own” for home ownership. For example, the threshold displayed in visualization 232 may be between 5 and 10%, but nearly 25% of the data records accessed by the user are associated with “own” as the value for home ownership. Therefore, the suggestion 230 may include one or more selectable options to bring the data record accesses for “own” as the value for home ownership in line with the threshold for “own”. For example, by selecting the help me element 244, the guidance module may identify data records that, when accessed by the user, cause the user to access data records associated with renting. In some embodiments, the guidance module identifies and returns the data records that have the greatest impact on causing the data record accesses for a particular data type to approximate the associated threshold. In some embodiments, the guidance module computes a score for the data records, where the score reflects the impact. The score may be based on at least one or more data record accesses by the user and one or more associated thresholds, such that the score reflects the impact of the associated data record accesses for a target threshold (e.g., home ownership data record accesses and the home ownership threshold) without negatively impacting other thresholds (e.g., age thresholds and data accesses associated with age ranges). Therefore, in some embodiments, the guidance module computes the scores to identify a subset of the data records to return to the user (e.g., via the visualizations 232, data records component 216, guidance component 218, and/or other attributes component 220).

For example, the guidance module returns one or more data records in the data records component 216 that are associated with renting. As another example, the guidance module highlights data records associated with renting in the chart 238 (e.g., by applying a visual indication such as a highlight effect, bold effect, flashing, changing colors, and/or changing a size of the point in the chart 238 corresponding to the identified data record). Doing so may guide the user to select these data records to cause the access to approach the threshold.

The other attributes component 220 includes additional suggestions generated by the guidance module. For example, as shown, suggestion 236 specifies that the threshold associated with “venture” for the “loan intent” data type is exceeded by the number of data records associated with “venture” accessed by the user. The “help me” buttons associated with suggestion 236 causes the guidance module to suggest adding a filter using the user focus wildcard element, which when selected, refreshes the data records component 216 with data records that remove the over emphasis on venture loan intent. However, by selecting the reject element 246, the user ignores the suggestion, which causes the desired focus to be applied in the GUI 200. As shown, the GUI 200 further provides input means to snooze a suggestion for a predetermined amount of time, at which point the guidance module resurfaces the suggestion. Similarly, the GUI 200 provides input means to mute a suggestion such that the suggestion is ignored and is not resurfaced by the guidance module. Suggestions remain accessible via the tabs at the top of the guidance component 218 (e.g., Active, Completed, Snoozed, Muted, Rejected).

Similarly, age attribute visualization 224 provides a visualization of the data records (and corresponding ages) accessed by the user relative to the corresponding age threshold. Therefore, as shown in the age attribute visualization 224, the user has not accessed data records of users having ages less than 30 or greater than 45. Similarly, as shown in default history attribute visualization 226, the user is below the threshold for accessing data records that are not associated with a default, while exceeding the threshold for data records that are associated with a default.

In some embodiments, the guidance module groups suggestions by attributes 210 and ranks suggestions in the guidance component 218 in the descending order of attribute distribution, ranging from 1 to 0. For each attribute, the guidance module ranks suggestions in the guidance component 218 in the descending order of the differences between the observed user focus and the target threshold, e.g., if the “own” category for the categorical attribute “home ownership type” has more deviation than the “rent” category, “own” will be ranked higher, indirectly suggesting the user to focus on records associated with renting.

FIG. 2C depicts an interface for managing threshold values, according to an embodiment. As stated, the thresholds may include thresholds that are proportional to the distribution of data values, thresholds that are equal (e.g., 1 divided by “N”, where N corresponds to the number of possible values for a data type), or user-defined custom thresholds. For example, using movie rating threshold selection element 258 and custom radio button 284, the user specifies custom threshold values for different movie rating types (e.g., by defining custom values of 0.15, 0.1, 0.4, and 0.35). The custom values may be provided by any input means, such as sliding the bars associated with each rating, typing in the values, etc. For quantitative attributes, users can sketch a target distribution by clicking (to add new quantiles) and dragging points in the presented interactive histogram. However, by selecting proportional radio button 280, the guidance module adjusts the thresholds to match the distribution of movie ratings in the data records as shown in content rating chart 262. Similarly, selecting the equal radio button 282 causes the guidance module to define thresholds such that each value has an equal threshold (e.g., 0.25 for each of the 4 movie ratings), as shown in content rating chart 274. Similarly, movie runtime threshold selection element 260 allows the selection between proportional, equal, or custom thresholds. In FIG. 2C, proportional threshold section 252 reflects proportional thresholds, equal threshold section 254 reflects equal thresholds, and the custom threshold section 256 includes custom thresholds.

For example, content rating chart 262 shows movie content ratings, associated thresholds, and the percentage of data records accessed by the user (e.g., via GUI 200). Therefore, as shown, content rating threshold 264 for “R” rated movies is above the content rating focus 266 for R-rated movies, where content rating focus 266 reflects the percentage of data records accessed by the user that are associated with R movie ratings. Similarly, runtime graph 268 depicts, for movie run times, a line of runtime data thresholds 270, and the runtime data focus 272 depicts the actual accesses of data records by the user for the corresponding movie run time. Therefore, as shown, the user is above the threshold for some movie run times (e.g., 60 minute run times), but below the threshold for other movie run times (e.g., 120 minute runtimes).

For equal threshold section 254, the thresholds are equal. For example, in content rating chart 274, content rating threshold 276 and content rating focus 278 reflect that the user has accessed a number of data records having R-ratings that is below the content rating threshold 276.

In the custom threshold section 256, the user-defined thresholds in movie rating threshold selection element 258 and/or runtime threshold selection element 260 are applied. Therefore, for example, content rating chart 286 shows content rating focus 290 is approximately equal to content rating threshold 288. Embodiments are not limited in these contexts.

As stated, the guidance module may interact with the user over time to deliver different types and/or amounts of suggestions to the user. For example, if a user successfully uses show me element 138, but later is able to select a wildcard element without guidance, the guidance module may refrain from showing suggestions similar to suggestion element 130. Similarly, as the user interacts with the analysis application, the guidance module learns from the user. For example, when the user specifies a proportional threshold, the guidance module may default to proportional thresholds for the user.

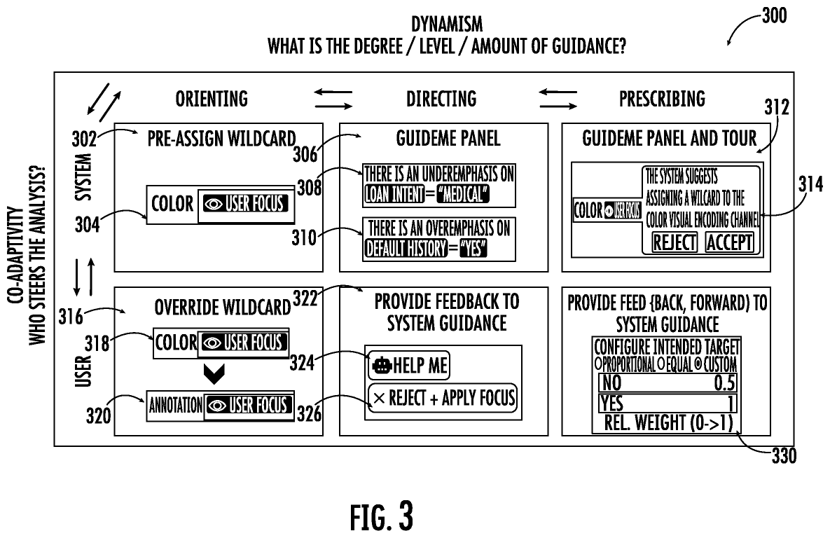

More generally, FIG. 3 is a schematic 300 illustrating different types of suggestions that the guidance module provides. Different types of guidance and/or suggestions include, but are not limited to, orienting, directing, and prescribing. For example, orienting guidance may be a lower, basic degree of guidance that merely orients the user. Orienting guidance builds or maintains the user's mental map. Such a map contains potential targets and paths as well as relations among them. One strategy for orienting users is to provide visual cues hinting at these targets and paths. Therefore, guidance suggestions include the guidance module pre-assigning a wildcard to an interface element (e.g., of the encodings component 212) as shown in wildcard assignment 302. For example, the assigned wildcard 304 associates the wildcard of user focus with the color element of the encodings component 212. However, in wildcard override 316, the user may ignore the suggested wildcard 318 (e.g., “user focus” to color) and provide a selected wildcard 320 to the annotation element of encodings component 212.

Other examples of orienting guidance include programmatically mapping wildcards to the visual encodings in the encodings component 212. For example, programmatically assigning “User Focus” wildcard to “color” in the encodings component 212 colors the datapoints in the visualization component 214 and as the mini glyphs in the attribute view (e.g., age attribute visualization 224) in proportion to their focus values. For example, in age attribute visualization 224 and/or visualization component 214 darker points indicate that the user has interacted with them more than the lighter points and the system is nudging the user to proceed one way or the other. As stated, a wildcard can be dragged to X, Y, Color, Size, Shape, Stroke, Opacity, Row, Column, Text, Detail, Annotation, Tooltip of the encodings component 212. The aforementioned operations can be suggested by the guidance module (e.g., asking the user to drag one or more attributes or wildcards and assign them to one or more visual encodings) and/or performed by the guidance module programmatically.

Directing guidance may be a medium degree of guidance. In contrast to orienting, directing guidance emphasizes a preference for a future course of action. The guidance module presents the user with a set of alternative options to produce the desired result, or a set of similar results. The suggestions differ in terms of quality and costs for different paths leading to the same result or, in terms of interest for paths, leading to similar or new results. Directing guidance can include preview techniques that help users make informed decisions for one or the other option.

Directing guidance therefore includes guidance panel 306, where the guidance module returns feedback related to user focus (e.g., the number of selected records) and the related thresholds. For example, suggestion 308 indicates that the user has selected a number of records associated with medical loan intent that are below the associated threshold. Similarly, suggestion 310 indicates that the user has selected a number of records associated with a loan default that are above the associated threshold. Feedback elements 322 allow the user to provide direct and/or indirect feedback to the guidance module. For example, the help element 324 allows the user to directly request help from the guidance module, while reject element 326 allows the user to reject a suggestion and implicitly provide feedback to the guidance module.

Directing guidance may allow the user to accept a suggestion and apply the associated focus. For example, by accepting the recommendation of the guidance module, the guidance module may assign wildcards and/or other attributes 210 to fields in the encodings component 212, assign wildcards to filters, and/or zoom into a specific part of a visualization. More generally, by allowing the user to select from different thresholds, the guidance module may receive feedback from the user. For example, when the user overrides the proportional threshold suggested by the guidance module in favor of custom thresholds, the guidance module may learn from the user's actions. Similarly, when the user rejects a suggested threshold, the guidance module may recompute custom threshold values and present the custom threshold values to the user.

Prescribing guidance may be a higher degree of guidance. In contrast to directing, prescribing guidance makes decisions on steps to be taken programmatically. Prescribing implements a largely automated process, which proceeds towards a specified target. Such a process may cover any (sub-)task of analysis regardless of its scope. In the context of visual analytics, intermediate steps of the process and the decisions that lead from one step to the next are visually presented. In a sense, prescribing guidance can be compared to an interactive presentation. A user may interrupt the presentation and ask for details, or rewind/reverse it to revisit a nugget of knowledge that has been found earlier. Depending on the degree of automation, the user can regain control for a while and nudge the presentation to another path or even another target.

Prescribing guidance therefore includes guidance panel 312, where suggestion 314 allows the user to reject or accept the suggestion to assign a wildcard to the color visual encoding channel of encodings component 212. The user can respond to these recommendations using “Accept and Fix Focus”, “Reject and Apply Focus”, “Mute”, or “Snooze” as described above. However, when the user selects Accept and Fix Focus, the guidance module takes over the GUI, taking the user on a guidance tour comprising a very specific sequence of steps all the way down to specific data points or attributes to interact with next. For example, prescribing guidance may automatically inspect an attribute, assign attributes/wildcards on certain visual encodings in the encodings component 212, zooming in to a specific chart/visualization region, or interact with a specific datapoint.

The guidance module therefore fluidly adapts to evolving user behavior and/or changing user preferences to provide appropriate amounts and degrees of guidance. For example, consider a user who is new to the analysis application. Initially, due to their limited experience, the user may prefer prescribing guidance (the highest degree of guidance) with step-by-step instructions on how to perform specific operations. As they become more acquainted with the analysis application, the user may want more directing or orienting (lower degrees of) system guidance to have multiple paths to choose from and also explore their hypotheses by themselves. Furthermore, since every user is unique and may have different preferences, the guidance module also offers users to specify if they have guidance preferences, e.g., ‘to only receive guidance via the “color” encoding channel and nothing else’. Consider another user who is a regular user of the analysis application. The another user may generally not require prescribing guidance at all, especially not during the initial phases of analysis, but only on demand when they are stuck. Such a user might prefer orienting guidance throughout their analysis to keep them oriented and may request higher degrees of guidance on demand, e.g., when they are stuck and in need of additional system guidance. This adaptive, dynamic guidance dialog allows all users and user levels to receive appropriate guidance.

FIG. 4 illustrates an embodiment of a system 400. The system 400 is suitable for implementing one or more embodiments as described herein. In one embodiment, for example, the system 400 is a computing system suitable for adaptive dynamic guidance in data analysis tools.

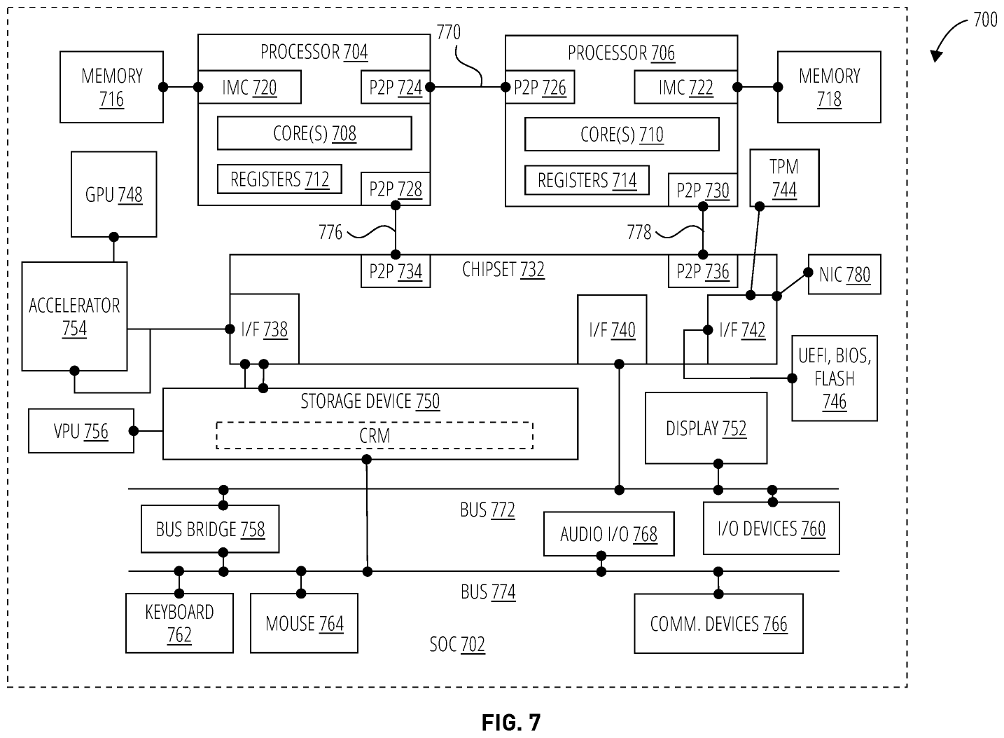

The system 400 comprises a set of M devices, where M is any positive integer. FIG. 4 depicts one computing device 404 (M=1). The computing device 404 is configured to implement all logic, features, functionality, interfaces, and methods described above with reference to FIGS. 1A-3. As depicted in FIG. 4, the computing device 404 includes processing circuitry 418, a memory 420, a storage medium 422, an interface 424, an analysis application 426, a logging module 428, and a guidance module 430. In some implementations, the computing device 404 includes other components or devices as well. Examples for software elements and hardware elements of the computing device 404 are described in more detail with reference to a computing architecture 700 as depicted in FIG. 7. Embodiments are not limited to these examples.

The analysis application 426, logging module 428, and the guidance module 430 are representative of the analysis application, logging module, and guidance modules described with reference to FIG. 1A-FIG. 3, respectively. More generally, the analysis application 426 provides the GUIs 100-200 and is designed to collect, process, analyze, and visualize data records 432 in the data repository 416. The data repository 416 may be any type of data storage solution. In some embodiments, the data records 432 in the data repository are row/column based, where data attributes (or data types) are defined in columns, and rows store corresponding data values. The guidance module 430 is designed to assist users by providing helpful suggestions such as suggestions 230, 234, 236, 308, or 310. The logging module 428 generates one or more interaction logs 434 describing user interaction events within the analysis application 426, including any interaction with the GUIs 100, 200. The events include button clicks, mouse hovering, accessing data records, wildcard selections, accepted suggestions, rejected suggestions, assigning values in the encodings component 212, selecting threshold types, defining threshold values, menu selections, form submissions, and any other actions within the analysis application 426. Records in the interaction logs 434 include timestamps, an identifier of a user, an indication of the event, and an indication of any associated data records in the data repository 416.

For example, the logging module 428 logs the interactions of a plurality of users of the analysis application 426 in the interaction logs 434. In some embodiments, the logging module 428 aggregates the data in the interaction logs 434. Based on the interaction logs 434, the guidance module 430 generates and stores one or more wildcard elements in the wildcard data 436. The wildcard data 436 is representative of any type of wildcard element, such as the organizational data usage wildcard element 104, organizational data focus wildcard element 106, user data usage wildcard element 108, and user data focus wildcard element 110. The guidance module 430 presents the wildcards from the wildcard data 436 based on analyzing the data records 432, the user (or users) accessing the data, and/or the interaction logs 434.

Operations for the disclosed embodiments are further described with reference to the following figures. Some of the figures include a logic flow. Although such figures presented herein include a particular logic flow, the logic flow merely provides an example of how the general functionality as described herein is implemented. Further, a given logic flow does not necessarily have to be executed in the order presented unless otherwise indicated. Moreover, not all acts illustrated in a logic flow are required in some embodiments. In addition, the given logic flow is implemented by a hardware element, a software element executed by one or more processing devices, or any combination thereof. The embodiments are not limited in this context.

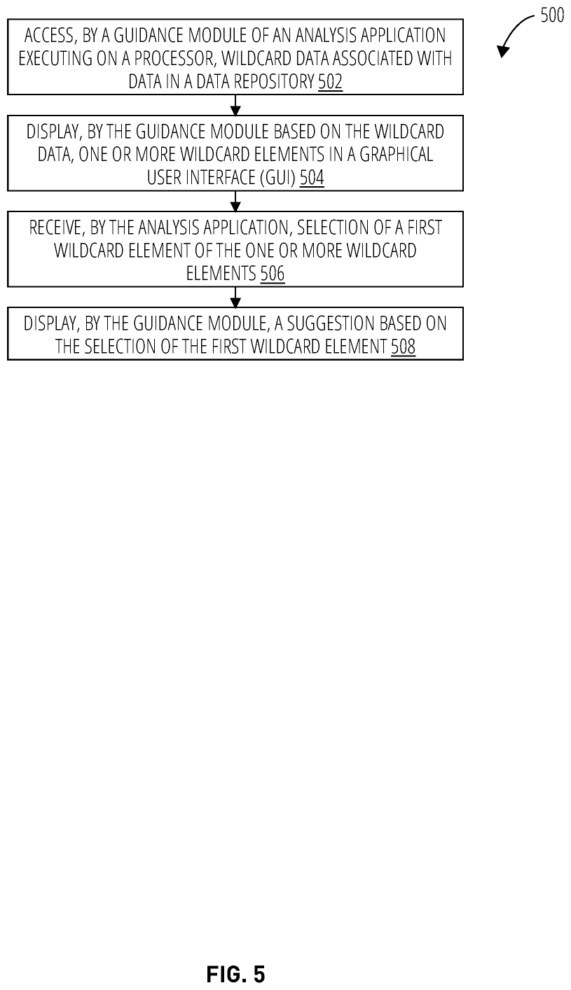

FIG. 5 illustrates an embodiment of a logic flow 500. The logic flow 500 is representative of some or all of the operations executed by one or more embodiments described herein. For example, the logic flow 500 includes some or all of the operations performed by devices or entities within the system 400 or the computing device 404. In one embodiment, the logic flow 500 is implemented as instructions stored on a non-transitory computer-readable storage medium, such as the storage medium 422, that when executed by the processing circuitry 418 causes the processing circuitry 418 to perform the described operations. The storage medium 422 and processing circuitry 418 may be co-located, or the instructions may be stored remotely from the processing circuitry 418. Collectively, the storage medium 422 and the processing circuitry 418 may form a system.

In block 502, logic flow 500 accesses, by a guidance module 430 of an analysis application 426 executing on a processor, wildcard data 436 associated with data records in a data repository 416. In block 504, logic flow 500 displays, by the guidance module 430 based on the wildcard data 436, one or more wildcard elements in a graphical user interface (GUI) such as GUIs 100 or 200. In block 506, logic flow 500 receives, by the analysis application 426, selection of a first wildcard element of the one or more wildcard elements. In block 508, logic flow 500 displays, by the guidance module 430, a suggestion based on the selection of the first wildcard element.

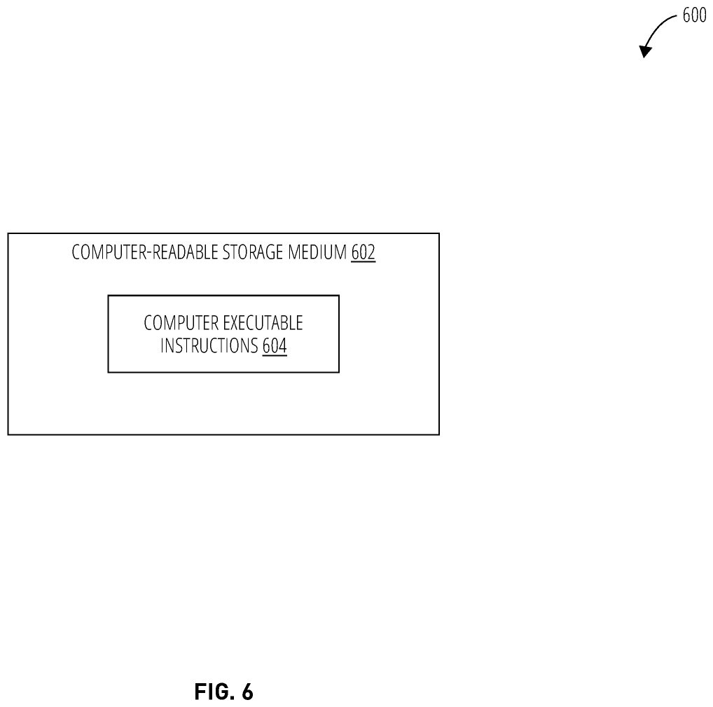

FIG. 6 illustrates an apparatus 600. Apparatus 600 comprises any non-transitory computer-readable storage medium 602 or machine-readable storage medium, such as an optical, magnetic or semiconductor storage medium. In various embodiments, apparatus 600 comprises an article of manufacture or a product. In some embodiments, the computer-readable storage medium 602 stores computer executable instructions with which one or more processing devices or processing circuitry can execute. For example, computer executable instructions 604 includes instructions to implement operations described with respect to any application, module, logic, or logic flows described herein (e.g., at least instructions for the analysis application 426, guidance module 430, and/or logging module 428). Examples of computer-readable storage medium 602 or machine-readable storage medium include any tangible media capable of storing electronic data, including volatile memory or non-volatile memory, removable or non-removable memory, erasable or non-erasable memory, writeable or re-writeable memory, and so forth. Examples of computer executable instructions 604 include any suitable type of code, such as source code, compiled code, interpreted code, executable code, static code, dynamic code, object-oriented code, visual code, and the like.

FIG. 7 illustrates an embodiment of a computing architecture 700. Computing architecture 700 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 700 has a single processor with one core or more than one processor. Note that the term “processor” refers to a processor with a single core or a processor package with multiple processor cores. In at least one embodiment, the computing architecture 700 is representative of the components of the system 400. More generally, the computing architecture 700 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 700. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the uni-directional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 7, computing architecture 700 comprises a system-on-chip (SoC) 702 for mounting platform components. System-on-chip (SoC) 702 is a point-to-point (P2P) interconnect platform that includes a first processor 704 and a second processor 706 coupled via a point-to-point interconnect 770 such as an Ultra Path Interconnect (UPI). In other embodiments, the computing architecture 700 is another bus architecture, such as a multi-drop bus. Furthermore, each of processor 704 and processor 706 are processor packages with multiple processor cores including core(s) 708 and core(s) 710, respectively. While the computing architecture 700 is an example of a two-socket (2S) platform, other embodiments include more than two sockets or one socket. For example, some embodiments include a four-socket (4S) platform or an eight-socket (8S) platform. Each socket is a mount for a processor and may have a socket identifier. Note that the term platform refers to a motherboard with certain components mounted such as the processor 704 and chipset 732. Some platforms include additional components and some platforms include sockets to mount the processors and/or the chipset. Furthermore, some platforms do not have sockets (e.g. SoC, or the like). Although depicted as a SoC 702, one or more of the components of the SoC 702 are included in a single die package, a multi-chip module (MCM), a multi-die package, a chiplet, a bridge, and/or an interposer. Therefore, embodiments are not limited to a SoC.

The processor 704 and processor 706 are any commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures are also employed as the processor 704 and/or processor 706. Additionally, the processor 704 need not be identical to processor 706.

Processor 704 includes an integrated memory controller (IMC) 720 and point-to-point (P2P) interface 724 and P2P interface 728. Similarly, the processor 706 includes an IMC 722 as well as P2P interface 726 and P2P interface 730. IMC 720 and IMC 722 couple the processor 704 and processor 706, respectively, to respective memories (e.g., memory 716 and memory 718). Memory 716 and memory 718 are portions of the main memory (e.g., a dynamic random-access memory (DRAM)) for the platform such as double data rate type 4 (DDR4) or type 5 (DDR5) synchronous DRAM (SDRAM). In the present embodiment, the memory 716 and the memory 718 locally attach to the respective processors (i.e., processor 704 and processor 706). In other embodiments, the main memory couple with the processors via a bus and shared memory hub. Processor 704 includes registers 712 and processor 706 includes registers 714.

Computing architecture 700 includes chipset 732 coupled to processor 704 and processor 706. Furthermore, chipset 732 are coupled to storage device 750, for example, via an interface (I/F) 738. The I/F 738 may be, for example, a Peripheral Component Interconnect-enhanced (PCIe) interface, a Compute Express Link® (CXL) interface, or a Universal Chiplet Interconnect Express (UCIe) interface. Storage device 750 stores instructions executable by circuitry of computing architecture 700 (e.g., processor 704, processor 706, GPU 748, accelerator 754, vision processing unit 756, or the like). For example, storage device 750 can store instructions for the computing device 404, analysis application 426, guidance module 430, and/or logging module 428.

Processor 704 couples to the chipset 732 via P2P interface 728 and P2P 734 while processor 706 couples to the chipset 732 via P2P interface 730 and P2P 736. Direct media interface (DMI) 776 and DMI 778 couple the P2P interface 728 and the P2P 734 and the P2P interface 730 and P2P 736, respectively. DMI 776 and DMI 778 is a high-speed interconnect that facilitates, e.g., eight Giga Transfers per second (GT/s) such as DMI 3.0. In other embodiments, the processor 704 and processor 706 interconnect via a bus.

The chipset 732 comprises a controller hub such as a platform controller hub (PCH). The chipset 732 includes a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 732 comprises more than one controller hub such as a chipset with a memory controller hub, a graphics controller hub, and an input/output (I/O) controller hub.

In the depicted example, chipset 732 couples with a trusted platform module (TPM) 744 and UEFI, BIOS, FLASH circuitry 746 via I/F 742. The TPM 744 is a dedicated microcontroller designed to secure hardware by integrating cryptographic keys into devices. The UEFI, BIOS, FLASH circuitry 746 may provide pre-boot code. The I/F 742 may also be coupled to a network interface circuit (NIC) 780 for connections off-chip.

Furthermore, chipset 732 includes the I/F 738 to couple chipset 732 with a high-performance graphics engine, such as, graphics processing circuitry or a graphics processing unit (GPU) 748. In other embodiments, the computing architecture 700 includes a flexible display interface (FDI) (not shown) between the processor 704 and/or the processor 706 and the chipset 732. The FDI interconnects a graphics processor core in one or more of processor 704 and/or processor 706 with the chipset 732.

The computing architecture 700 is operable to communicate with wired and wireless devices or entities via the network interface (NIC) 780 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network is used to connect computers to each other, to the Internet, and to wired networks (which use IEEE 802.3-related media and functions).

Additionally, accelerator 754 and/or vision processing unit 756 are coupled to chipset 732 via I/F 738. The accelerator 754 is representative of any type of accelerator device (e.g., a data streaming accelerator, cryptographic accelerator, cryptographic co-processor, an offload engine, etc.). One example of an accelerator 754 is the Intel® Data Streaming Accelerator (DSA). The accelerator 754 is a device including circuitry to accelerate copy operations, data encryption, hash value computation, data comparison operations (including comparison of data in memory 716 and/or memory 718), and/or data compression. Examples for the accelerator 754 include a USB device, PCI device, PCIe device, CXL device, UCIe device, and/or an SPI device. The accelerator 754 also includes circuitry arranged to execute machine learning (ML) related operations (e.g., training, inference, etc.) for ML models. Generally, the accelerator 754 is specially designed to perform computationally intensive operations, such as hash value computations, comparison operations, cryptographic operations, and/or compression operations, in a manner that is more efficient than when performed by the processor 704 or processor 706. Because the load of the computing architecture 700 includes hash value computations, comparison operations, cryptographic operations, and/or compression operations, the accelerator 754 greatly increases performance of the computing architecture 700 for these operations.

The accelerator 754 includes one or more dedicated work queues and one or more shared work queues (each not pictured). Generally, a shared work queue is configured to store descriptors submitted by multiple software entities. The software is any type of executable code, such as a process, a thread, an application, a virtual machine, a container, a microservice, etc., that share the accelerator 754. For example, the accelerator 754 is shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 754 via a non-posted write (e.g., a deferred memory write (DMWr)). One example of an instruction that atomically submits a work descriptor to the shared work queue of the accelerator 754 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 754. The dedicated work queue may accept job submissions via commands such as the movdir64b instruction.

Various I/O devices 760 and display 752 couple to the bus 772, along with a bus bridge 758 which couples the bus 772 to a second bus 774 and an I/F 740 that connects the bus 772 with the chipset 732. In one embodiment, the second bus 774 is a low pin count (LPC) bus. Various input/output (I/O) devices couple to the second bus 774 including, for example, a keyboard 762, a mouse 764 and communication devices 766.

Furthermore, an audio I/O 768 couples to second bus 774. Many of the I/O devices 760 and communication devices 766 reside on the system-on-chip (SoC) 702 while the keyboard 762 and the mouse 764 are add-on peripherals. In other embodiments, some or all the I/O devices 760 and communication devices 766 are add-on peripherals and do not reside on the system-on-chip (SoC) 702.

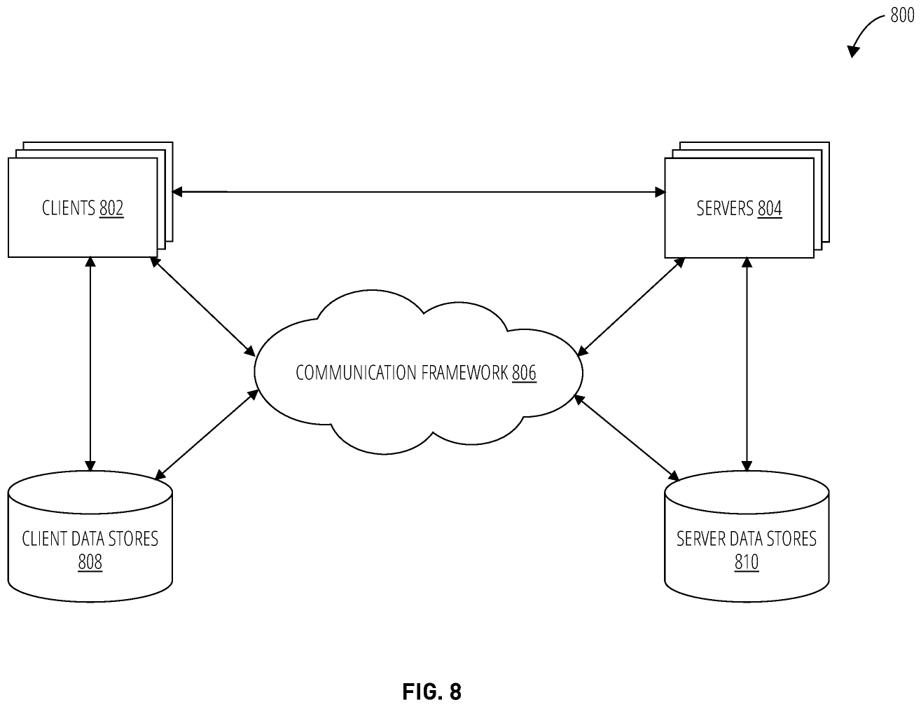

FIG. 8 illustrates a block diagram of an exemplary communications architecture 800 suitable for implementing various embodiments as previously described. The communications architecture 800 includes various common communications elements, such as a transmitter, receiver, transceiver, radio, network interface, baseband processor, antenna, amplifiers, filters, power supplies, and so forth. The embodiments, however, are not limited to implementation by the communications architecture 800.

As shown in FIG. 8, the communications architecture 800 includes one or more clients 802 and servers 804. The clients 802 and the servers 804 are operatively connected to one or more respective client data stores 808 and server data stores 810 that can be employed to store information local to the respective clients 802 and servers 804, such as cookies and/or associated contextual information.

The clients 802 and the servers 804 communicate information between each other using a communication framework 806. The communication framework 806 implements any well-known communications techniques and protocols. The communication framework 806 is implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 806 implements various network interfaces arranged to accept, communicate, and connect to a communications network. A network interface is regarded as a specialized form of an input output interface. Network interfaces employ connection protocols including without limitation direct connect, Ethernet (e.g., thick, thin, twisted pair 10/400/1000 Base T, and the like), token ring, wireless network interfaces, cellular network interfaces, IEEE 802.11 network interfaces, IEEE 802.16 network interfaces, IEEE 802.20 network interfaces, and the like. Further, multiple network interfaces are used to engage with various communications network types. For example, multiple network interfaces are employed to allow for the communication over broadcast, multicast, and unicast networks. Should processing requirements dictate a greater amount speed and capacity, distributed network controller architectures are similarly employed to pool, load balance, and otherwise increase the communicative bandwidth required by clients 802 and the servers 804. A communications network is any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The various elements of the devices as previously described with reference to the figures include various hardware elements, software elements, or a combination of both. Examples of hardware elements include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements varies in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application or a firmware application executed by one or more processors. The one or more processors are internal or external to the apparatus and execute at least a part of the software or firmware application. As yet another example, a component is an apparatus that provides specific functionality through electronic components without mechanical parts; the electronic components include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not necessarily intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

Various embodiments also relate to apparatus or systems for performing these operations. This apparatus is specially constructed for the required purpose or it comprises a general purpose computer as selectively activated or reconfigured by a computer program stored in the computer. The procedures presented herein are not inherently related to a particular computer or other apparatus. Various general purpose machines are used with programs written in accordance with the teachings herein, or it proves convenient to construct more specialized apparatus to perform the required method steps. The required structure for a variety of these machines are apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The following examples pertain to further embodiments, from which numerous permutations and configurations will be apparent.

Example 1 includes a computer-implemented method, comprising: accessing, by a guidance module of an analysis application executing on a processor, wildcard data associated with data in a data repository; displaying, by the guidance module based on the wildcard data, one or more wildcard elements in a graphical user interface (GUI); receiving, by the analysis application, selection of a first wildcard element of the one or more wildcard elements; and displaying, by the guidance module, a suggestion based on the selection of the first wildcard element.

Example 2 includes the subject matter of example 1, wherein displaying the suggestion comprises: displaying, by the guidance module, one or more data types in the data repository and an indication to provide a first data type of the one or more data types to a focus wildcard element of the GUI.

Example 3 includes the subject matter of example 2, further comprising: receiving, by the guidance module via the GUI, an indication of acceptance of the suggestion; providing, by the guidance module, the first data type to the focus wildcard element in the GUI; and displaying, by the analysis application, data elements of the first data type in the GUI.

Example 4 includes the subject matter of example 1, further comprising prior to accessing the wildcard data: generating the wildcard data by aggregating, by a logging module, respective use amounts of a plurality of data elements in the data repository; and aggregating, by the logging module, respective focus amounts for the plurality of data elements in the data repository.

Example 5 includes the subject matter of example 4, wherein the suggestion comprises an ordered subset of the aggregated use amounts or an ordered subset of the aggregated focus amounts.

Example 6 includes the subject matter of example 4, further comprising prior to generating the wildcard data: logging, by the logging module, respective use instances for the plurality of data elements in the analysis application; and logging, by the logging module, respective focus instances for the plurality of data elements in the analysis application.

Example 7 includes the subject matter of example 1, wherein displaying the one or more wildcard elements comprises: determining, by the guidance module, a respective organizational data use amount for a plurality of data types in the data repository; determining, by the guidance module, a respective organizational data focus amount for the plurality of data types in the data repository, wherein the organizational data use amounts and the organizational data focus amounts are associated with a plurality of users of the analysis application; determining, by the guidance module, a user data use amount for the plurality of data types; and determining, by the guidance module, a user data focus amount for the plurality of data types, wherein the user data use amounts and the user data focus amounts are associated with one of the plurality of users of the analysis application.

Example 8 includes a system comprising: a memory component; and one or more processing devices coupled to the memory component, the one or more processing devices to perform operations comprising: determining, by a guidance module of an analysis application, a threshold for a data type in a data repository; determining, by the guidance module, a focus amount for the data type by a user of the analysis application; and displaying, by the guidance module in a graphical user interface (GUI) of the analysis application, a suggestion based on the threshold and the focus amount.

Example 9 includes the subject matter of example 8, wherein the threshold is based one of: (i) respective amounts of data values of the data type, (ii) equal amounts of data values of the data type and other data types, or (iii) user input.

Example 10 includes the subject matter of example 8, the one or more processing devices to perform operations comprising: receiving, by the guidance module, acceptance of the suggestion; and displaying, by the guidance module in the GUI, one or more data records of the data type from the data repository.

Example 11 includes the subject matter of example 8, wherein displaying the suggestion comprises: determining, by the guidance module, that the focus amount is not equal to the threshold; determining, by the guidance module, a subset of data records of the data type in the data repository; and displaying, by the guidance module, the subset of the data records in the GUI.

Example 12 includes the subject matter of example 11, the one or more processing devices to perform operations comprising: receiving, by the analysis application, selection of a data record of the subset of data records; updating, by a logging module, the focus amount based on the selection of the data record; and displaying, by the logging module, another suggestion based on the updated focus amount and the threshold.

Example 13 includes the subject matter of example 8, the one or more processing devices to perform operations comprising: receiving, by the analysis application, a modified threshold for the data type; and displaying, by the guidance module, another suggestion based on the modified threshold for the data type and the focus amount for the data type.

Example 14 includes a non-transitory computer-readable storage medium storing executable instructions, which when executed by one or more processing devices, cause the one or more processing devices to perform operations comprising: receiving, by a guidance module of an analysis application, wildcard data associated with data in a data repository; displaying, by the guidance module in a graphical user interface (GUI), a suggestion based the wildcard data; receiving, by the guidance module, an indication of acceptance of the suggestion; and providing, by the guidance module, a first data type to a focus wildcard element in the GUI; and displaying, by the analysis application based on providing the first data type to the focus wildcard element, data elements of the first data type in the GUI.

Example 15 includes the subject matter of example 14, wherein the instructions further cause the one or more processing devices to perform operations comprising: receiving, by the analysis application via a filter component of the GUI, a filtering value; and filtering, by the analysis application, the data elements of the first data type displayed in the GUI based on the filtering value, wherein the filtering removes at least one data element of the first data type from display in the GUI.

Example 16 includes the subject matter of example 14, wherein the suggestion further comprises respective indications of a plurality of data types including the first data type.

Example 17 includes the subject matter of example 16, wherein the suggestion further comprises respective use amounts of the plurality of data types.

Example 18 includes the subject matter of example 14, wherein the instructions further cause the one or more processing devices to, prior to accessing the wildcard data, perform operations comprising: generating the wildcard data by aggregating, by a logging module, respective use amounts of a plurality of data elements in the data repository; and aggregating, by the logging module, respective focus amounts for the plurality of data elements in the data repository.

Example 19 includes the subject matter of example 18, wherein the suggestion is based on use amounts and focus amounts associated with: (i) a user, or (ii) a plurality of users including the user.

Example 20 includes the subject matter of example 14, wherein the instructions further cause the one or more processing devices to perform operations comprising: determining, by the guidance module, a threshold for the first data type; determining, by the guidance module, a focus amount for the first data type by a user of the analysis application; and displaying, by the guidance module in the GUI, another suggestion based on the threshold and the focus amount.

What is claimed is:

1. A computer-implemented method, comprising:
accessing, by a guidance module of an analysis application executing on a processor, wildcard data associated with data in a data repository;
displaying, by the guidance module based on the wildcard data, one or more wildcard elements in a graphical user interface (GUI);
receiving, by the analysis application, selection of a first wildcard element of the one or more wildcard elements; and
displaying, by the guidance module, a suggestion based on the selection of the first wildcard element.

2. The computer-implemented method of claim 1, wherein displaying the suggestion comprises:
displaying, by the guidance module, one or more data types in the data repository and an indication to provide a first data type of the one or more data types to a focus wildcard element of the GUI.

3. The computer-implemented method of claim 2, further comprising:
receiving, by the guidance module via the GUI, an indication of acceptance of the suggestion;
providing, by the guidance module, the first data type to the focus wildcard element in the GUI; and
displaying, by the analysis application, data elements of the first data type in the GUI.

4. The computer-implemented method of claim 1, further comprising prior to accessing the wildcard data:
generating the wildcard data by:
aggregating, by a logging module, respective use amounts of a plurality of data elements in the data repository; and
aggregating, by the logging module, respective focus amounts for the plurality of data elements in the data repository.

5. The computer-implemented method of claim 4, wherein the suggestion comprises an ordered subset of the aggregated use amounts or an ordered subset of the aggregated focus amounts.

6. The computer-implemented method of claim 4, further comprising prior to generating the wildcard data:
logging, by the logging module, respective use instances for the plurality of data elements in the analysis application; and
logging, by the logging module, respective focus instances for the plurality of data elements in the analysis application.

7. The computer-implemented method of claim 1, wherein displaying the one or more wildcard elements comprises:
determining, by the guidance module, a respective organizational data use amount for a plurality of data types in the data repository;
determining, by the guidance module, a respective organizational data focus amount for the plurality of data types in the data repository, wherein the organizational data use amounts and the organizational data focus amounts are associated with a plurality of users of the analysis application;
determining, by the guidance module, a user data use amount for the plurality of data types; and
determining, by the guidance module, a user data focus amount for the plurality of data types, wherein the user data use amounts and the user data focus amounts are associated with one of the plurality of users of the analysis application.

8. A system comprising:
a memory component; and
one or more processing devices coupled to the memory component, the one or more processing devices to perform operations comprising:
determining, by a guidance module of an analysis application, a threshold for a data type in a data repository;
determining, by the guidance module, a focus amount for the data type by a user of the analysis application; and
displaying, by the guidance module in a graphical user interface (GUI) of the analysis application, a suggestion based on the threshold and the focus amount.

9. The system of claim 8, wherein the threshold is based one of: (i) respective amounts of data values of the data type, (ii) equal amounts of data values of the data type and other data types, or (iii) user input.

10. The system of claim 8, the one or more processing devices to perform operations comprising:
receiving, by the guidance module, acceptance of the suggestion; and
displaying, by the guidance module in the GUI, one or more data records of the data type from the data repository.

11. The system of claim 8, wherein displaying the suggestion comprises:
determining, by the guidance module, that the focus amount is not equal to the threshold;
determining, by the guidance module, a subset of data records of the data type in the data repository; and
displaying, by the guidance module, the subset of the data records in the GUI.

12. The system of claim 11, the one or more processing devices to perform operations comprising:
receiving, by the analysis application, selection of a data record of the subset of data records;
updating, by a logging module, the focus amount based on the selection of the data record; and
displaying, by the logging module, another suggestion based on the updated focus amount and the threshold.

13. The system of claim 8, the one or more processing devices to perform operations comprising:
receiving, by the analysis application, a modified threshold for the data type; and
displaying, by the guidance module, another suggestion based on the modified threshold for the data type and the focus amount for the data type.

14. A non-transitory computer-readable medium storing executable instructions, which when executed by one or more processing devices, cause the one or more processing devices to perform operations comprising:
receiving, by a guidance module of an analysis application, wildcard data associated with data in a data repository;
displaying, by the guidance module in a graphical user interface (GUI), a suggestion based the wildcard data;
receiving, by the guidance module, an indication of acceptance of the suggestion; and
providing, by the guidance module, a first data type to a focus wildcard element in the GUI; and
displaying, by the analysis application based on providing the first data type to the focus wildcard element, data elements of the first data type in the GUI.

15. The computer-readable storage medium of claim 14, wherein the instructions further cause the one or more processing devices to perform operations comprising:
receiving, by the analysis application via a filter component of the GUI, a filtering value; and
filtering, by the analysis application, the data elements of the first data type displayed in the GUI based on the filtering value, wherein the filtering removes at least one data element of the first data type from display in the GUI.

16. The computer-readable storage medium of claim 14, wherein the suggestion further comprises respective indications of a plurality of data types including the first data type.

17. The computer-readable storage medium of claim 16, wherein the suggestion further comprises respective use amounts of the plurality of data types.

18. The computer-readable storage medium of claim 14, wherein the instructions further cause the one or more processing devices to, prior to accessing the wildcard data, perform operations comprising:
generating the wildcard data by:
aggregating, by a logging module, respective use amounts of a plurality of data elements in the data repository; and
aggregating, by the logging module, respective focus amounts for the plurality of data elements in the data repository.

19. The computer-readable storage medium of claim 18, wherein the suggestion is based on use amounts and focus amounts associated with: (i) a user, or (ii) a plurality of users including the user.

20. The computer-readable storage medium of claim 14, wherein the instructions further cause the one or more processing devices to perform operations comprising:
determining, by the guidance module, a threshold for the first data type;
determining, by the guidance module, a focus amount for the first data type by a user of the analysis application; and
displaying, by the guidance module in the GUI, another suggestion based on the threshold and the focus amount.
